(19) United States
(12) Patent Application Publication
(10) Pub. No.: US 2004/0264014 A1
(43) Pub. Date: Dec. 30, 2004

(54) Mirror assembly

(76) Inventors: Robert T. Skilliter III, Curtice, OH (US); Anthony P. Pietrowski, Clay Center, OH (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/464,819

(22) Filed: Jun. 18, 2003

(51) Int. Cl. G02B 7/182

(52) U.S. Cl. 359/872

(57) ABSTRACT

A mirror assembly including a mirror positioned in a housing. The mirror has a cylindrical radial shape for improved visibility. The mirror assembly includes a bracket attached to the housing for mounting the housing and mirror on an interior surface of a motor vehicle such as a bus.

### BACKGROUND OF THE INVENTION

The present invention relates generally to a mirror assembly. More specifically, the invention is directed to a mirror assembly for use in a vehicle such as a school bus.

In the past, rear vision in a standard school bus has been accomplished by a flat rectangular mirror mounted directly above the driver. It has been found that this type of mirror provides limited visibility. Further, the mirror is difficult to adjust without tools, creates safety hazards if broken, and is heavy.

There is a need for a mirror assembly that improves visibility. Further, there is a need for a mirror assembly that is easy to adjust without tools, durable and lightweight. The present invention satisfies these and other needs.

### SUMMARY OF THE INVENTION

The present invention is directed to a mirror assembly comprising a mirror having a cylindrical radial shape positioned in a housing. A bracket is attached to the housing for mounting the mirror on a surface.

The primary object of the present invention is to provide a mirror assembly that allows for greater visibility.

It is an important object of the present invention to provide a mirror assembly that is easy to adjust without tools.

It is another important object of the present invention to provide a mirror assembly that is durable.

It is another important object of the present invention to provide a mirror assembly that is lightweight.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a front perspective view of a mirror assembly according to the present invention;

FIG. 2 is a back elevational view thereof;

FIG. 3 is a top view thereof;

FIG. 4 is a cross-sectional view taken along line 4-4 of FIG. 2;

FIG. 5 is a cross-sectional view taken along line 5-5 of FIG. 4; and

FIG. 6 is a top diagrammic view of an embodiment of a mirror according the present invention.

### DETAILED DESCRIPTION OF THE PREFERRED EMBODIMENTS

The preferred embodiments and best mode of the present invention will now be described in detail with reference being made to the drawings. The mirror assembly of the present invention is identified generally in the drawings by the reference number “10”.

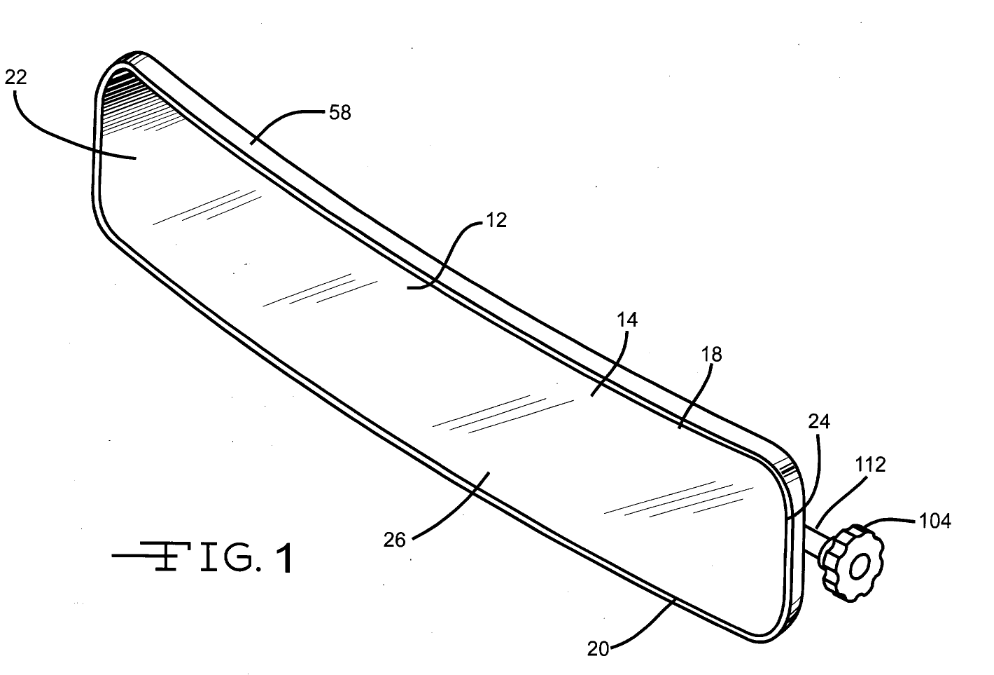

Referring to FIG. 1, 4 and 6, the mirror assembly 10 includes a mirror 12 having a front 14, a back 16, a top 18, a bottom 20, a first end 22 and a second end 24. The mirror 12 is horizontally elongated from the first end 22 to the second end 24. The front 14 includes a smooth and continuous reflective surface 26. A silver coated surface 28 is positioned on the back 16.

Still referring to FIGS. 1, 4 and 6, the mirror 12 has a cylindrical radial shape that provides the user with greater visibility as opposed to a conventional flat mirror. For example, if the mirror assembly 10 is positioned above the driver of a school bus, the driver has improved visibility of the inside of the bus because the mirror 12 optically shortens the length of the bus and brings the far rear of the bus within better view of the driver. Accordingly, the driver has a clear view of the occupants seated in the back seats of the bus.

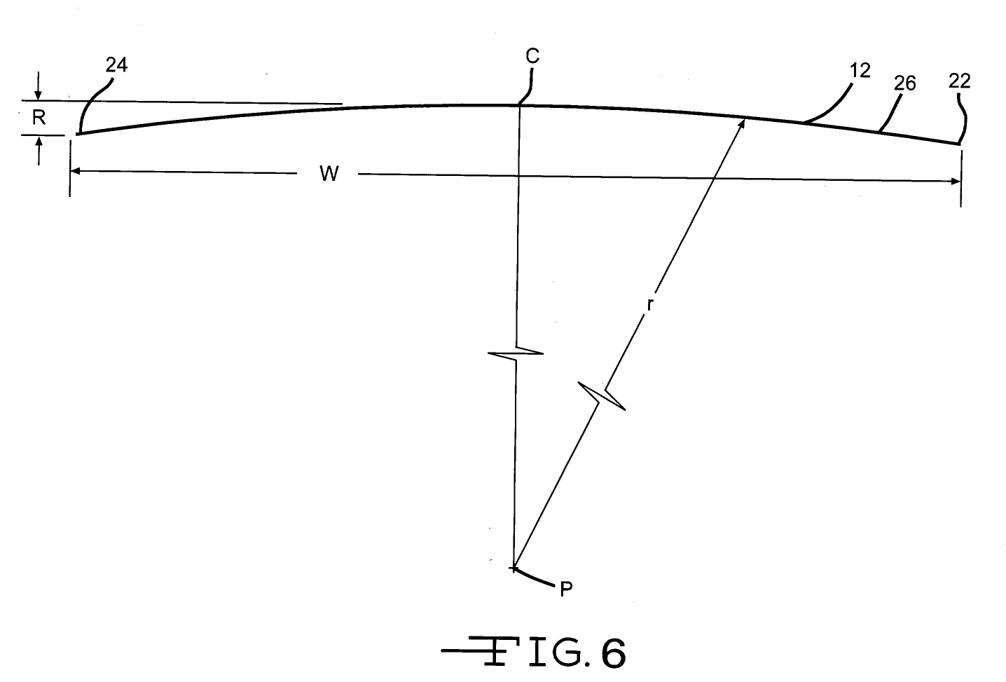

As shown in FIG. 6, the cylindrical radial shape of the mirror 12 is defined by a radius r extending from a point P as determined by the width W of the mirror 12, as measured from the first end 22 to the second end 24, and the rise R as measured from either the first end 22 or the second end 24 and the center C of mirror 12. It has been found that the mirror 12 can have a cylindrical radial shape defined by a radius r in the range of from about 200 inches to about 250 inches.

In a preferred embodiment, as shown in FIGS. 1, 4 and 6, the mirror 12 has a 6 inch height, as measured from the top 18 to the bottom 20, a 30 inch width W, as measured from the first end 22 to the second end 24 and an ⅛ inch thickness, as measured from the front 14 to the back 16. The mirror 12 has a 1 inch rise R, as measured from the second end 24 to the plane defined by the center point C as shown in FIG. 6. Accordingly, the radius r defining the cylindrical radial shape of the mirror 12 of this embodiment is about 226 inches. In a preferred embodiment, the mirror 12 is constructed of fully tempered safety mirror glass that provides durability and safety.

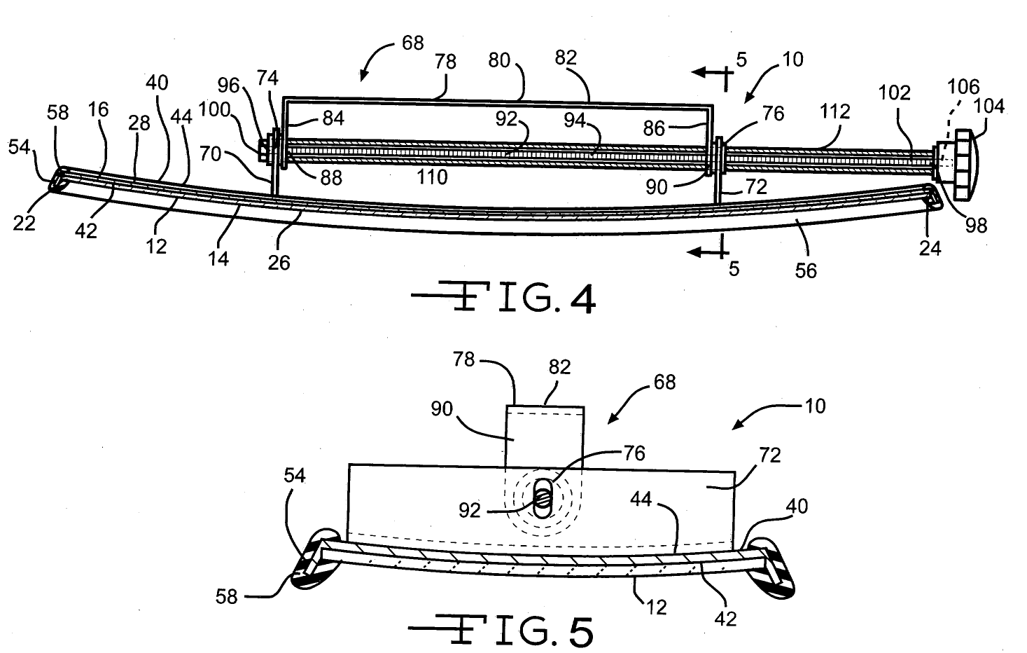

Referring to FIGS. 1-5, the mirror assembly 10 includes a housing 40 having a front 42, a back 44, a top 46, a bottom 48, a first end 50 and a second end 52. As shown in FIGS. 4 and 5, the housing 40 includes a flange 54 that extends outwardly from the front 42 along the top, bottom, first end and second end 46-52 of the housing. The front 42 and the flange 54 form a compartment 56 that is sized and adapted to receive the mirror 12. As shown in FIG. 4, the front 42 of the housing 40 has a cylindrical radial shape that complements the shape of the mirror 12. The mirror 12 is fixedly attached to the front 42 by adhesive. As shown in FIGS. 1-5, a polyvinyl chloride (PVC) gasket 58 extends along the top, bottom, first end and second end 46-52 of the housing 40. As shown in FIG. 5, the gasket 58 includes a recess 60 that is sized and adapted to receive the flange 54 of the housing 40. The gasket 58 is fixedly attached to the housing 40 by adhesive. In a preferred embodiment, the housing 40 is constructed of lightweight aluminum. This makes the mirror assembly 10 relatively lightweight as compared to prior mirror structures. The combination of the preferred ⅛ inch thick safety mirror glass of the mirror 12 with the lightweight aluminum housing 40 provides an approximately thirty percent (30%) weight savings over previous structures.

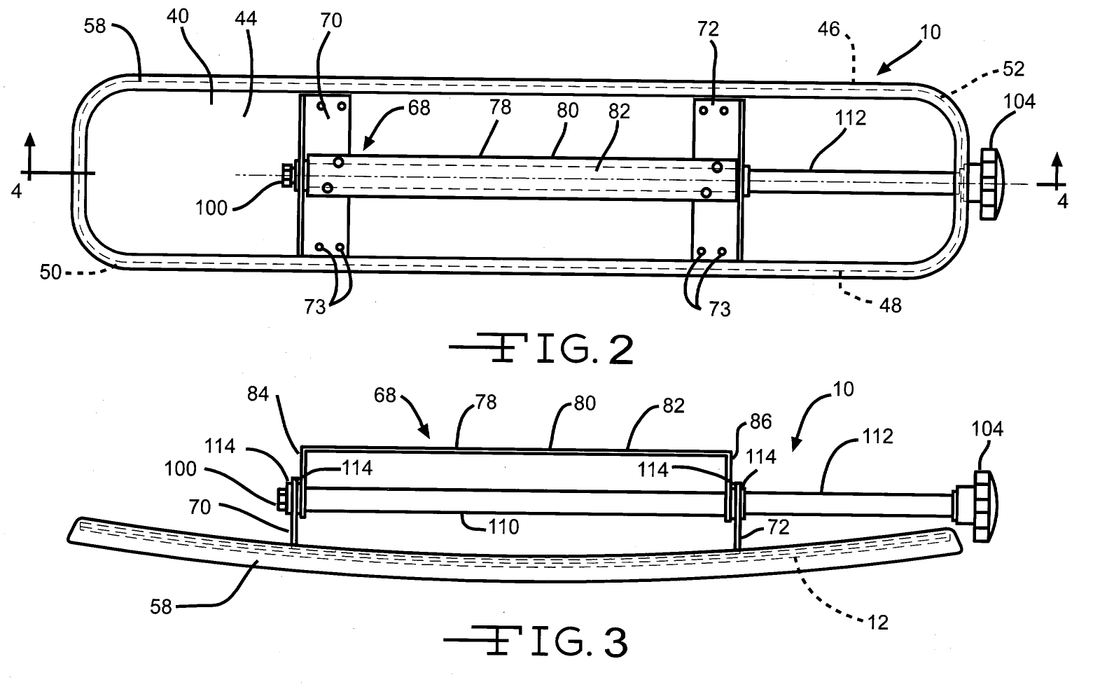

Referring to FIGS. 2-5, the mirror assembly 10 includes a bracket 68 attached to the back 44 of the housing 40 for mounting the mirror assembly on a surface. The bracket 68 includes first and second stationary members 70 and 72 that are positioned on the back 44 of the housing 40 by rivets 73. The first and second stationary members 70 and 72 extend outwardly from the back 44 in spaced relation to one another. The first and second stationary members 70 and 72 define elongated oval first and second stationary member openings 74 and 76, respectively.

Still referring to FIGS. 2-5, the bracket 68 includes a mounting member 78 having a longitudinally extending mounting portion 80 having an engagement surface 82. The mounting member 78 includes first and second legs 84 and 86 that extend perpendicularly to the mounting portion 80 in spaced relation to one another. The first and second legs 84 and 86 define round first and second leg openings 88 and 90, respectively. The first and second legs 84 and 86 are positioned between the first and first and second stationary members 70 and 72 so that the first and second stationary member openings 74 and 76 are aligned with the first and second leg openings 88 and 90. The first and second stationary members 70 and 72 and the mounting member 78 are constructed of steel for durability and strength.

Referring to FIGS. 4 and 5, the bracket 68 includes a rod 92 having a generally cylindrical elongated body 94 including a first end 96 and a second end 98. The rod 92 extends through the first-and second stationary member openings 74 and 76 and the first and second leg openings 88 and 90. Referring to FIGS. 2-4, the rod 92 is a carriage bolt having a stop member or head 100 positioned at the first end 96 and a threaded portion 102 at the second end 98. In an alternative embodiment, the rod 96 can be an all-thread rod in which threads extend along the entire exterior surface of the body 94. In the alternative embodiment, the stop member 100 is a lock nut that is positioned on the first end 96. As shown in FIG. 4, the head 100 is positioned adjacent to the first stationary member 70 and the second end 98 extends beyond the second end 52 of the housing 40. The rod 92 is constructed of aluminum for durability and strength.

As shown in FIGS. 3 and 4, the bracket 68 includes a turning device or knob 104 that includes a threaded opening 106 that is sized and adapted to mate with the threaded portion 102 of the rod 92. Accordingly, the knob 104 can be turned to travel along the rod 92. In a preferred embodiment, the knob 104 is constructed of plastic with the threaded opening 102 being constructed of metal.

Still referring to FIGS. 3 and 4, the bracket 68 includes a first spacer 110 positioned between the first and second legs 84 and 86 and a second spacer 112 positioned between the second stationary member 72 and the knob 104. The first and second spacers 110 and 112 are hollow tubes through which the rod 92 extends. In a preferred embodiment, the first and second spacers 110 and 112 are constructed of low density polyethylene (LDPE) plastic. In an alternative embodiment, the first and second spacers 110 and 112 are constructed of metal. The first spacer 110 is sized and adapted to fit snuggly between the first and second legs 84 and 86. The second spacer 112 is sized and adapted to allow the knob 104 to engage and release the second spacer 112 as the knob is being turned.

As shown in FIG. 3, the bracket 68 includes at least two fiber washers 114 in which one is positioned between the head 100 and the first stationary member 70 and the other one is positioned between the second spacer 112 and the second stationary member 72. As shown in FIG. 3, washers 114 can also be positioned between the first stationary member 70 and the first leg 84 and between the second stationary member 72 and the second leg 86.

The operation and use of the present invention will now be described. The mirror assembly 10 is positioned, for example, above the driver's seat of a bus by attaching the mounting member 78 of the bracket 68 to the header section of the bus so that the engagement surface 82 engages the header section. When seated in the driver's seat, a driver can look at the reflective surface 26 of the mirror 12 to determine if there is a clear view the passenger compartment of the bus. If adjustment is necessary, the driver can turn the knob 104 in the counter-clockwise direction to cause the knob 104 to travel outwardly along the rod 92 so that the knob releases the second spacer 112. The release of the second spacer 112 allows for the pivotal movement of the housing 40 and thus the mirror 12 along the axis defined by the rod 92 to adjust the mirror 12 up and down. The housing 40 and thus the mirror 12 can also be further moved along the plane of travel of the rod 92 as defined by the elongated first and second stationary member openings 74 and 76 to adjust the mirror 12 forward and backward. Once the driver has made the necessary adjustments, the knob 104 can be turned in a clockwise direction so that it engages the second spacer 112 to apply force on the second stationary member 72. The tightening of the knob 104 also causes the head 100 to apply force on the first stationary member 70. The first and second stationary members 70 and 72 move inwardly to clamp the first and second legs 84 and 86, respectively, against the first spacer 110. Once the knob 104 is fully tightened, the mounting member 78 and the first and second stationary members 70 and 72 are secured or locked in place thereby securing the housing 40 and thus the mirror 12 in the position determined by the driver. As it will be appreciated, adjustments to the mirror assembly 10 can be made without tools.

The mirror assembly 10 of the present invention provides the driver with improved visibility of the passenger compartment. This allows the driver to recognize and correct potential problems that might arise with the passengers. Further, the mirror assembly 10 is easy to adjust, durable and lightweight.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. A mirror assembly comprising a mirror having a cylindrical radial shape positioned in a housing, and a bracket.

2. The mirror assembly of claim 1, wherein said mirror is constructed of fully tempered safety mirror glass.

3. The mirror assembly of claim 1, wherein said cylindrical radial shape is defined by a radius in the range of from about 200 inches to about 250 inches.

4. The mirror assembly of claim 1, wherein said housing is constructed of lightweight aluminum.

5. The mirror assembly of claim 1, wherein said housing includes a front and a back, said mirror being positioned on said front and said bracket being positioned on said back.

6. The mirror assembly of claim 1, wherein said bracket includes a stationary member attached to said back a mounting member and a pivoting member operatively connected to said stationary and mounting members.

7. The mirror assembly of claim 5, wherein said bracket includes first and second stationary members positioned on said back of said housing in spaced relation, said first and second stationary members having first and second stationary member openings, respectively, said bracket further includes a mounting member having a mounting portion and first and second legs in spaced relation, said first and second legs having first and second mounting member openings, said bracket further including a rod extending through said first and second stationary member openings and said first and second mounting member openings.

8. The mirror assembly of claim 7, wherein said first and second mounting member openings being elongated.

9. The mirror assembly of claim 7, wherein said rod has a cylindrical body including a first end and a second end, a stop member being positioned on said first end and a turning device being positioned on said second end.

10. The mirror assembly of claim 9, wherein a first spacer is positioned over said rod between said first and second legs of said mounting member and a second spacer is positioned over said rod between said second stationary member and said turning device.
